(19) United States
(12) Patent Application Publication
(10) Pub. No.: US 2026/0301665 A1
(43) Pub. Date: Oct. 1, 2026

(54) METHOD AND SYSTEM FOR GENERATING AN IMAGE, DEVICE, ELECTRONIC EQUIPMENT AND STORAGE MEDIUM

(71) Applicant: SOUTHERN UNIVERSITY OF SCIENCE AND TECHNOLOGY, Shenzhen, Guangdong (CN)

(72) Inventors: Xiaowei SUN, Shenzhen, Guangdong (CN); Philip Anthony SURMAN, Shenzhen, Guangdong (CN)

(73) Assignee: SOUTHERN UNIVERSITY OF SCIENCE AND TECHNOLOGY, Shenzhen, Guangdong (CN)

(21) Appl. No.: 19/479,166

(22) PCT Filed: Oct. 31, 2023
(86) PCT No.: PCT/CN2023/128425

§ 371 Date: Oct. 27, 2025

(30) Foreign Application Priority Data
Apr. 28, 2023 (CN) 202310484113.2

(51) Int. Cl. G09G 3/3208; G09G 3/00; H04N 13/305; H04N 13/324; H04N 13/398

(52) U.S. Cl. CPC G09G 3/3208; G09G 3/003; G09G 2300/0439; G09G 2320/0209; G09G 2320/0242; H04N 13/305; H04N 13/324; H04N 13/398

(57) ABSTRACT

A method includes: acquiring original pixel data of an image to be displayed, where the original pixel data comprises image pixel data; acquiring pixel arrangement structure data for an OLED display screen, where the pixel arrangement structure data comprises display pixel data arranged in a preset arrangement direction; performing a mapping operation according to the image pixel data and the display pixel data to obtain original mapped pixel data; determining target pixel data in the original mapped pixel data according to a preset target direction and the preset arrangement direction; and performing a pixel value adjustment operation on the target pixel data in the original mapped pixel data to obtain target mapped pixel data.

### CROSS-REFERENCE TO RELATED APPLICATIONS

The present application claims priority to Chinese Application No. 202310484113.2, filed on Apr. 28, 2023 and entitled “METHOD AND SYSTEM FOR GENERATING AN IMAGE, DEVICE, ELECTRONIC EQUIPMENT AND STORAGE MEDIUM,” the entire contents of which are incorporated herein by reference.

### TECHNICAL FIELD

The invention relates to the technical field of display, in particular to a method and system for generating an image, device, electronic equipment and storage medium.

### BACKGROUND

At present, a glasses-free 3D display device based on a lenticular lens and an OLED display screen is generally provided with an OLED display screen and a lenticular lens. The lenticular lens is arranged at the display end of the OLED display screen and configured to perform image processing on an image generated by the OLED display screen.

In existing technologies, the lenticular lens includes a plurality of columnar areas, and a certain angle is formed between an arrangement direction of each columnar area and an arrangement direction of subpixel arrays in the OLED display screen. Subpixel multiplexing may occur in the OLED display screen, which will aggravate image crosstalk in the direction perpendicular to the arrangement direction of columnar areas of the lenticular lens.

### SUMMARY

The present disclosure aims at solving at least one of the technical problems in the existing technology. In view of this, a method for generating an image is provided according to some embodiments of the present disclosure, which can reduce the image crosstalk of an image to be displayed.

A system for generating an image, and electronic equipment and computer-readable storage medium for implementing the above method are further provided according to some embodiments of the present disclosure.

In accordance with a first aspect of the present disclosure, an embodiment provides a method for generating an image, which is applied to an Organic Light Emitting Diode (OLED) display device including an OLED display screen. The method includes following steps:
acquiring original pixel data of an image to be displayed, where the original pixel data includes image pixel data;
acquiring pixel arrangement structure data for the OLED display screen, where the pixel arrangement structure data includes display pixel data arranged in a preset arrangement direction;
performing a mapping operation according to the image pixel data and the display pixel data to obtain original mapped pixel data;
determining target pixel data in the original mapped pixel data according to a preset target direction and the preset arrangement direction; and
performing a pixel value adjustment operation on the target pixel data in the original mapped pixel data to obtain target mapped pixel data, where the OLED display screen is configured to display a “regenerated” image to be displayed according to the target mapped pixel data.

The method according to some embodiments of the present disclosure has at least the following beneficial effects. The original pixel data of an image to be displayed is acquired, where the original pixel data includes image pixel data. Next, pixel arrangement structure data of the OLED display screen is acquired, where the pixel arrangement structure data includes display pixel data arranged according to a preset arrangement direction. Then, a mapping operation is performed according to the image pixel data and the display pixel data to obtain original mapped pixel data, and target pixel data in the original mapped pixel data is determined according to the preset target direction and the preset arrangement direction. Finally, a pixel value adjustment operation on the target pixel data in the original mapped pixel data is performed to obtain target mapped pixel data, so that the OLED display screen is able to display the “regenerated” image to be displayed according to the target mapped pixel data. According to the method of the embodiments of the present disclosure, the pixel value of the subpixels in the direction perpendicular to the setting direction of the lenticular lens can be adjusted, thereby reducing the image crosstalk of the image to be displayed resulting from subpixel multiplexing.

In some embodiments of the present disclosure, the image pixel data includes a first red image pixel, a first green image pixel and a first blue image pixel, and the display pixel data includes a first red display pixel(s), a first green display pixel(s) and a first blue display pixel(s).

The step of performing a mapping operation according to the image pixel data and the display pixel data to obtain original mapped pixel data includes:
performing, in response to the pixel arrangement structure data being a preset first arrangement structure data, the mapping operation according to one first green image pixel and one first green display pixel to obtain first green mapped pixel data; where, the first green display pixel has a first receiving direction, a second receiving direction, a third receiving direction and a fourth receiving direction, the first receiving direction and the second receiving direction are categorized as a first setting direction, the third receiving direction and the fourth receiving direction are categorized as a second setting direction, and the first setting direction is perpendicular to the second setting direction; the first red display pixels are arranged in the first receiving direction and the second receiving direction, and the first blue display pixels are arranged in the third receiving direction and the fourth receiving direction;
performing the mapping operation according to one first red image pixel and two first red display pixels to obtain first red mapped pixel data;
performing the mapping operation according to one first blue image pixel and two first blue display pixels to obtain first blue mapped pixel data; and
obtaining original mapped pixel data according to the first green mapped pixel data, the first red mapped pixel data and the first blue mapped pixel data.

In some embodiments of the present disclosure, the OLED display device further includes a lenticular lens arranged at a display end of the OLED display screen in a first preset direction; taking the first setting direction and the second setting direction as the preset arrangement direction, and taking the first preset direction as the present target direction.

The step of determining target pixel data in the original mapped pixel data according to the preset target direction and a preset arrangement direction includes:
taking, in response to the first setting direction being parallel to the first preset direction, the first blue mapped pixel data as the target pixel data; and
taking, in response to the second setting direction being parallel to the first preset direction, the first red mapped pixel data as the target pixel data.

In some embodiments of the present disclosure, the image pixel data includes a second red image pixel, a second green image pixel and a second blue image pixel, and the display pixel data includes a second red display pixel(s), a second green display pixel(s) and a second blue display pixel(s).

The step of performing a mapping operation according to the image pixel data and the display pixel data to obtain original mapped pixel data includes:
performing, in response to the pixel arrangement structure data being a preset second arrangement structure data, the mapping operation according to one second green image pixel and two second green display pixels to obtain second green mapped pixel data, where the second green display pixels are arranged in a third setting direction, the second red display pixel and the second blue display pixel are arranged in a fourth setting direction, and the third setting direction is perpendicular to the fourth setting direction;
performing the mapping operation according to one second red image pixel and one second red display pixel to obtain second red mapped pixel data;
performing the mapping operation according to one second blue image pixel and one second blue display pixel to obtain second blue mapped pixel data; and
obtaining the original mapped pixel data according to the second green mapped pixel data, the second red mapped pixel data and the second blue mapped pixel data.

In some embodiments of the present disclosure, the OLED display device further includes a lenticular lens arranged in a second preset direction, the third setting direction and the fourth setting direction are taken as the preset arrangement direction, and the second preset direction is taken as the preset target direction.

The step of determining target pixel data in the original mapped pixel data according to the preset target direction and a preset arrangement direction includes:
taking, in response to the fourth setting direction being parallel to the second preset direction, the second green mapped pixel data as the target pixel data.

In some embodiments of the present disclosure, the step of performing a pixel value adjustment operation on the target pixel data in the original mapped pixel data to obtain target mapped pixel data includes:
performing the pixel value adjustment operation on the target pixel data in the original mapped pixel data to obtain chromatic aberration pixel data; and
performing a color correction operation on the chromatic aberration pixel data to obtain the target mapped pixel data.

In accordance with a second aspect of the present disclosure, a system for generating an image includes:
an original pixel acquisition module, configured to acquire original pixel data of an image to be displayed, where the original pixel data includes image pixel data;
an arrangement structure acquisition module, configured to acquire pixel arrangement structure data of an OLED display screen, where the pixel arrangement structure data includes display pixel data arranged in a preset arrangement direction;
a mapping module, configured to perform a mapping operation according to the image pixel data and the display pixel data to obtain original mapped pixel data;
a target pixel acquisition module, configured to determine target pixel data in the original mapped pixel data according to a preset target direction and the preset arrangement direction; and
a pixel adjustment module, configured to perform a pixel value adjustment operation on the target pixel data in the original mapped pixel data to obtain target mapped pixel data, where the OLED display screen is configured to display “regenerated” image to be displayed according to the target mapped pixel data.

The system according to the embodiments of the present disclosure has at least the following beneficial effects: by the method of any one embodiment of the present disclosure, the image crosstalk of the image to be displayed caused by subpixel multiplexing can be reduced.

In accordance with a third aspect of the present disclosure, an OLED display device includes:
a controller, configured to execute the method according to any one of the above embodiments;
an OLED display screen, configured to electrically connect to the controller; and
a lenticular lens, arranged at a display end of the OLED display screen in a target direction.

In accordance with a fourth aspect of the present disclosure, an embodiment provides electronic equipment, which includes:
at least one processor; and
at least one memory storing at least one computer program which, when executed by the at least one processor, causes the at least one processor to carry out the method of any one of the embodiments of the present disclosure.

In accordance with a fifth aspect of the present disclosure, an embodiment provides a computer-readable storage medium. The storage medium stores a computer program which, when executed by a processor, causes the processor to carry out the method of any one of the embodiments of the present disclosure.

Additional aspects and advantages of the present disclosure will be illustrated in part in the following description, and in part will be apparent from the following description, or may be understood by practicing the present disclosure.

### BRIEF DESCRIPTION OF DRAWINGS

The present disclosure will be further described below with reference to accompanying drawings and embodiments, in which:

FIG. 1 is a schematic diagram showing the structure of an OLED display device according to an embodiment of the present disclosure;

FIG. 2 is a flowchart of a method for generating an image according to an embodiment of the present disclosure;

FIG. 3 is a schematic diagram showing pixels of an image to be displayed according to an embodiment of the present disclosure;

FIG. 4 is a schematic diagram showing an OLED display device according to an embodiment of the present disclosure;

FIG. 5 is a schematic diagram showing an OLED display screen according to an embodiment of the present disclosure;

FIG. 6 is a schematic diagram showing an OLED display device according to another embodiment of the present disclosure;

FIG. 7 is a schematic diagram showing an OLED display screen according to another embodiment of the present disclosure;

FIG. 8 is a flowchart of a step S300 of the method shown in FIG. 2 according to an embodiment of the present disclosure;

FIG. 9 is a flowchart of a step S400 of the method shown in FIG. 2 according to an embodiment of the present disclosure;

FIG. 10 is a schematic diagram showing subpixels of the OLED display screen with a first arrangement structure according to an embodiment of the present disclosure;

FIG. 11 is a flowchart of the step S300 of the method shown in FIG. 2 according to another embodiment of the present disclosure;

FIG. 12 dis a flowchart of the step S400 of the method shown in FIG. 2 according to another embodiment of the present disclosure;

FIG. 13 is a schematic diagram showing an arrangement of the subpixels of the OLED display screen with a second arrangement structure according to an embodiment of the present disclosure;

FIG. 14 is a flowchart of a step S500 of the method shown in FIG. 2 according to an embodiment of the present disclosure;

FIG. 15 dis a block diagram showing a system for generating an image according to an embodiment of the present disclosure; and

FIG. 16 is a schematic diagram showing a hardware structure of an electronic equipment according to an embodiment of the present disclosure.

### REFERENCE NUMERAL

OLED display screen 100, subpixel group 110, lenticular lens 200, original pixel acquisition module 310, arrangement structure acquisition module 320, mapping module 330, target pixel acquisition module 340, pixel adjustment module 350, processor 410, memory 420, input/output interface 430, communication interface 440 and bus 450.

### DETAILED DESCRIPTION

Embodiments of the present disclosure will be described in detail below. Examples of the embodiments are illustrated in the accompanying drawings, in which the same or similar reference numerals indicate the same or similar elements or elements having the same or similar functions throughout. The embodiments described below with reference to the accompanying drawings are exemplary, which are merely used for illustrating the present disclosure but cannot be understood as limitations to the present disclosure.

It should be understood that in the description of the present disclosure, the orientation or positional relationship related to orientation description, such as up, down, front, back, left, right, etc., is based on the azimuth or positional relationship shown in the accompanying drawings, which is merely for the convenience of illustrating the present disclosure and simplifying the description, but does not indicate or imply that the referred device or element must have a specific orientation, or be constructed and operated in a specific orientation, so it cannot be understood as a limitation of the present disclosure. It should be understood that in the description of the embodiments of the present disclosure, the term “several” means at least one, the term “a plurality of” (or multiple) means at least two, the term such as “greater than”, “less than”, “exceed” or variants thereof prior to a number or series of numbers is understood to be exclusive of the number(s). The term “above”, “below”, “within” and the like prior to a number or series of numbers is understood to be inclusive of the number(s). If used herein, the terms such as “first” and “second” and the like are merely used for distinguishing technical features, and are not intended to indicate or imply relative importance, or implicitly point out the number of the indicated technical features, or implicitly point out a precedence order of the indicated technical features.

In the description of the present disclosure, the terms “arrangement”, “installation”, “connection”, etc. should be broadly understood unless otherwise specified. The specific meanings of the above terms in the present disclosure can be reasonably determined by those skilled in the art in combination with the description of the technical scheme.

In the description of the present disclosure, the illustrations with reference to the terms “an embodiment”, “some embodiments”, “example embodiment”, “example” , “specific example” or “some examples” means that the specific features, structures, materials or characteristics described in combination with this embodiment or example are included in at least one embodiment or example of the present disclosure. In this description, the schematic expressions of the above terms do not necessarily refer to the same embodiment or example. Moreover, the specific features, structures, materials or characteristics described may be combined in any one or more embodiments or examples in a suitable manner.

It should be noted that in the following embodiments, the pixel arrangement structure of an OLED display screen includes a diamond arrangement structure and a “2-in-1” arrangement structure as examples. However, it should be understood that other types of pixel arrangement structures should fall within the scope of the embodiment of the present disclosure.

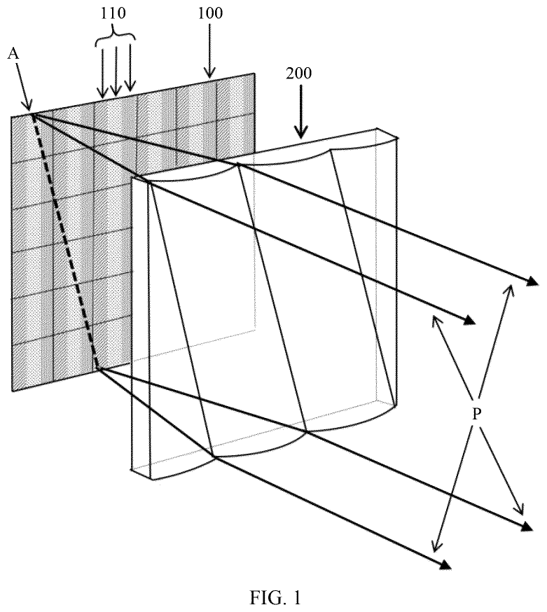

At present, naked-eye 3D devices based on cylindrical lenticular lens of OLED display screens are usually equipped with OLED display screens and lenticular lens. The lenticular lens is arranged at the display end of the OLED display screen to image the image generated by the OLED display screen. Referring to FIG. 1, a lenticular lens includes a plurality of columnar areas. The light may be emitted from a display end of the OLED display screen along a line segment A, and then is diffused after passing through one of the columnar areas of the lenticular lens to form an imaging area P.

In the existing technologies, a certain angle α is formed between the arrangement direction of each columnar area of the lenticular lens and of which the subpixel arrays in the OLED display screen. In this way, the lenticular lens is arranged at a display end of the OLED display screen at the slanted angle α. The image crosstalk resulting from subpixel multiplexing in OLED display screen can be aggravated in the direction perpendicular to the arrangement direction of columnar areas of the lenticular lens.

In view of this, a method and system for generating an image, device, electronic equipment, and storage medium are provided according to the embodiments of the present disclosure. The pixel value of the subpixel in the direction perpendicular to the arrangement direction of the lenticular lens can be adjusted, thereby avoiding the error in the assignment of the pixel value of the subpixel, and further reducing the image crosstalk in the “regenerated” image to be displayed.

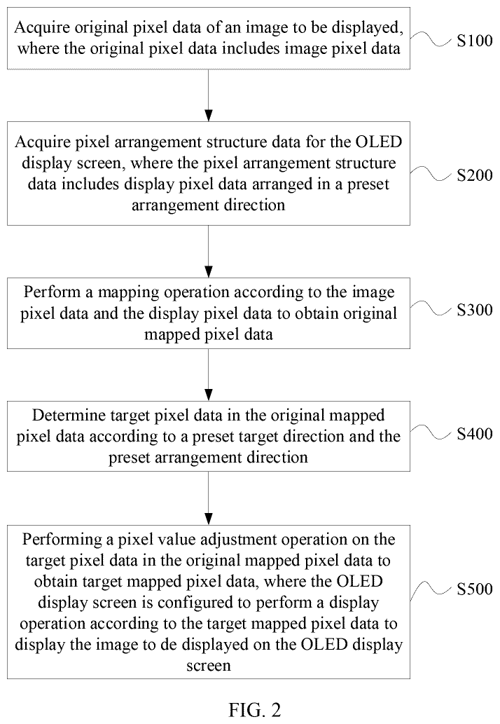

As shown in FIGS. 1 and 2, a method for generating an image is provided according to an embodiment of the present disclosure, which is applied to an OLED display device. The OLED display device includes an OLED display screen 100. The image generation method includes, but is not limited to, steps S100 to S500, which will be described in detail below.
At S100, original pixel data of an image to be displayed is acquired, the original pixel data includes image pixel data.
At S200, pixel arrangement data of an OLED display screen is acquired, the pixel arrangement data includes display pixel data arranged in a preset arrangement direction.
At S300, a mapping operation is performed according to the image pixel data and the display pixel data to obtain original mapped pixel data.
At S400, target pixel data in the original mapped pixel data is determined according to a preset target direction and the preset arrangement direction.
At S500, a pixel value adjustment is performed on the target pixel data in the original mapped pixel data to obtain target mapped pixel data, the OLED display screen 100 is configured to perform display operation according to the target mapped pixel data to display the image to be displayed on the OLED screen 100.

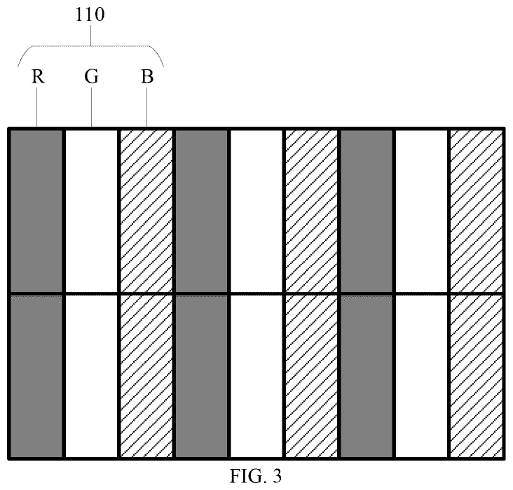

In some embodiments, at S100, the original pixel data of the image to be displayed is acquired. Referring to FIGS. 1 and 3, the image to be displayed may be represented by the combinations of three subpixels of red subpixel R, green subpixel G and blue subpixel B, in the form of matrix arrays. A subpixel group 110 is consisted of three adjacent subpixels including a red subpixel, a green subpixel and a blue subpixel. The original pixel data refers to the pixels making up the image to be displayed. The original pixel data includes image pixel data for representing pixel data of a subpixel group 110.

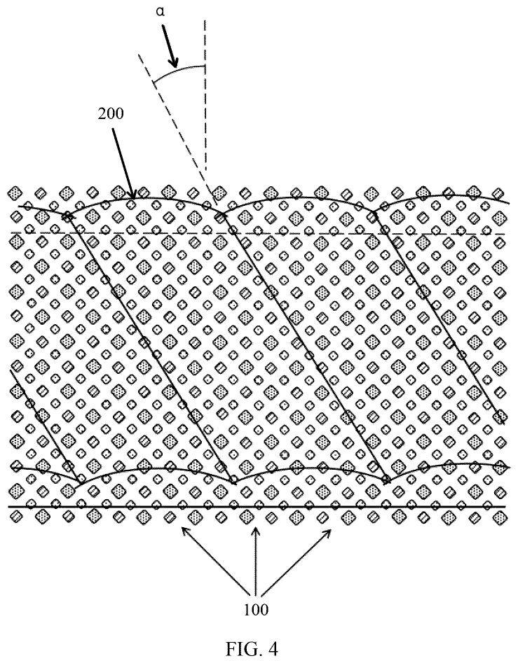

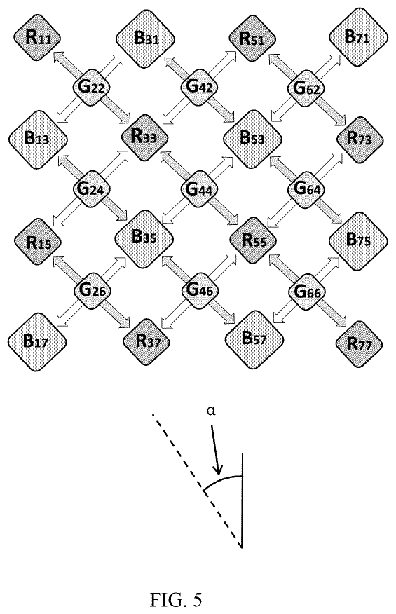

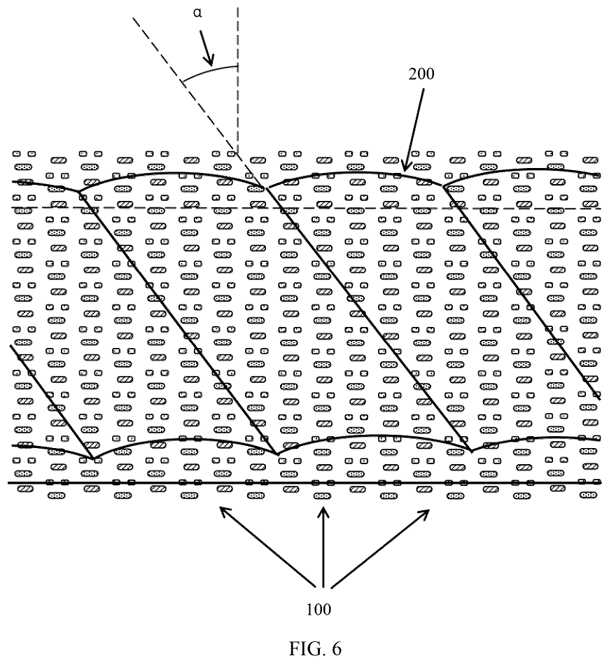

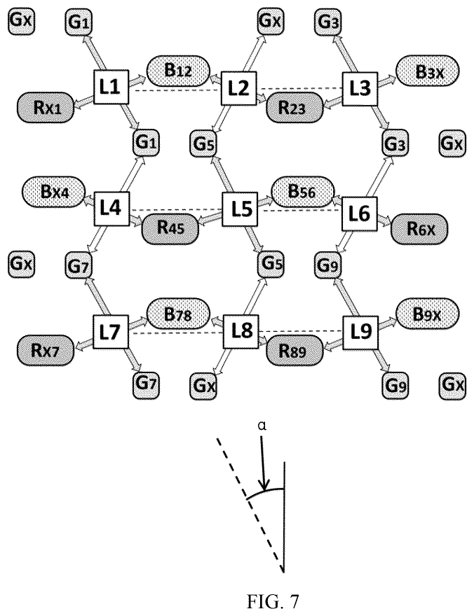

In some embodiments, at S200, the pixel arrangement structure data of the OLED display screen 100 is acquired. The pixel arrangement structure data is utilized to represent how the red, green and blue subpixels are arranged on the OLED display screen 100. The pixel arrangement types of the OLED display screen 100 may include a diamond arrangement type and a “2-in-1” arrangement type. FIGS. 4 and 5 are schematic diagrams depicting the OLED display screen 100 with a diamond arrangement. FIGS. 6 and 7 are schematic diagrams depicting the OLED display screen 100 with a “2-in-1” arrangement. The pixel arrangement data includes display pixel data, which is utilized to represent the distribution information of a subpixel group 110 in the preset arrangement direction.

In some embodiments, at S300, after the original pixel data and the pixel arrangement structure data are obtained, a mapping operation is performed according to the image pixel data and the display pixel data to obtain the original mapped pixel data. The mapping operation refers to the process of converting the subpixels arranged in the form of matrix arrays in the image to be displayed, to the subpixels arranged under the above-mentioned pixel arrangement structures. That is, the original mapped pixel data is the pixel value data of subpixels in the image to be displayed under the pixel arrangement structure of the OLED display screen.

In some embodiments, at S400, the target pixel data in the original mapped pixel data is determined according to the preset target direction and the preset arrangement direction. The preset target direction is a slant direction of the lenticular lens 200, as shown in FIG. 1. According to the target direction and the preset arrangement direction of the subpixels in the OLED display screen 100, in the OLED display screen 100 the subpixels whose arrangement directions are perpendicular to the target direction are determined, and the pixel value of the subpixels determined is taken as the target pixel data.

In some embodiments, at S500, the pixel value of the target pixel data in the original mapped pixel data is adjusted to obtain the target mapped pixel data, such that the OLED display screen 100 is able to carry out a display operation on the target mapped pixel data, to display the image to be displayed. The image crosstalk in the image to be displayed can be reduced by controlling the pixel value of the subpixels whose arrangement directions are perpendicular to the target direction.

In the method for generating an image according to the embodiments of the present disclosure, the original pixel data of an image to be displayed is acquired, where the original pixel data includes the image pixel data. Next, the pixel arrangement structure data of the OLED display screen 100 is acquired, where the pixel arrangement structure data includes the display pixel data arranged according to the preset arrangement direction. Then, the mapping operation is performed according to the image pixel data and the display pixel data to obtain the original mapped pixel data. The target pixel data in the original mapped pixel data is determined according to the preset target direction and the preset arrangement direction. Finally, the pixel value of the target pixel data in the original mapped pixel data is adjusted to obtain target mapped pixel data, so that the “regenerated” image to be displayed can be displayed on the OLED display screen 100 according to the target mapped pixel data. The pixel value of the subpixels in the direction perpendicular to the setting direction of the lenticular lens 200 can be adjusted according to the method of the embodiments of the present disclosure, thereby reducing the image crosstalk of the image to be displayed resulting from subpixel multiplexing.

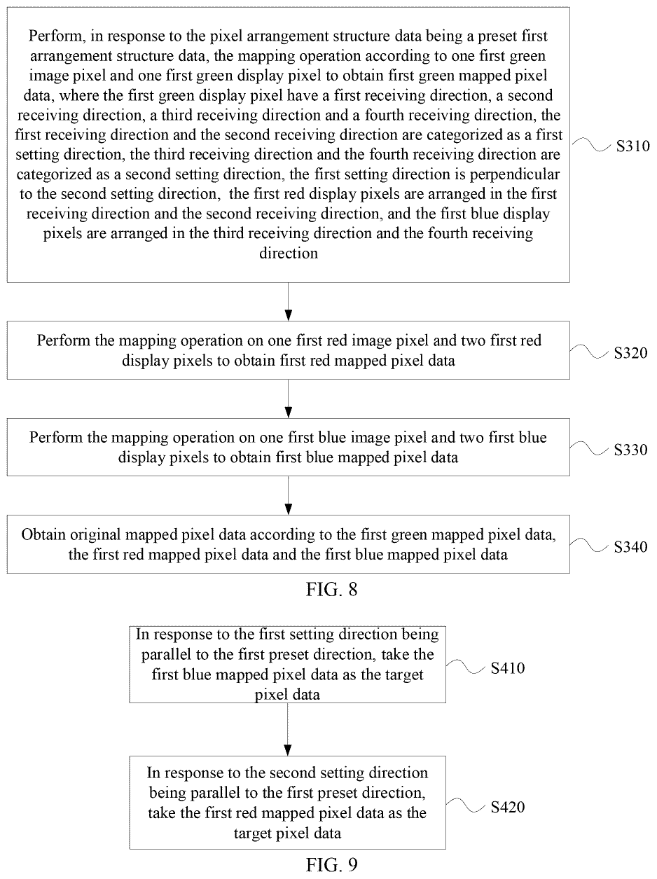

As shown in FIG. 8, in some embodiments of the present disclosure, the image pixel data includes a first red image pixel, a first green image pixel and a first blue image pixel. The display pixel data includes a first red display pixel(s), a first green display pixel(s) and a first blue display pixel(s). The step S300 may include, but is not limited to, steps S310 to S340, which will be described in detail below.
At S310, when the pixel arrangement structure data is a preset first arrangement structure data, the mapping operation is performed according to one first green image pixel and one first green display pixel to obtain first green mapped pixel data. The first green display pixel has a first receiving direction, a second receiving direction, a third receiving direction and a fourth receiving direction. The first receiving direction and the second receiving direction are categorized as a first setting direction, while the third receiving direction and the fourth receiving direction are categorized as a second setting direction, where the first setting direction is perpendicular to the second setting direction. The first red display pixels are arranged in the first and second receiving directions, and the first blue display pixels are arranged in the third and fourth receiving directions.
At S320, the mapping operation is performed according to one first red image pixel and two first red display pixels to obtain first red mapped pixel data.
At S330, the mapping operation is performed according to one first blue image pixel and two first blue display pixels to obtain first blue mapped pixel data.
At S340, original mapped pixel data is obtained according to the first green mapped pixel data, the first red mapped pixel data and the first blue mapped pixel data.

In some embodiments, at S310, the first arrangement structure is the diamond arrangement structure. In such a case, the mapping operation is performed according to a first green image pixel in the image pixel data and a first green display pixel data in the display pixel data to obtain first green mapped pixel data at S310. Referring to FIGS. 4 and 5, when the pixel arrangement structure is the diamond arrangement structure, a subpixel group in the OLED display screen 100 includes one green subpixel G, two red subpixels R and two blue subpixels B. For example, a subpixel group may be consisted of the green subpixel G22, the adjacent red subpixels R11 and R33, and the adjacent blue subpixels B13 and B31 in FIG. 5, and another subpixel group may be consisted of the green subpixel G24, the adjacent red subpixels R15 and R33, and the adjacent blue subpixels B13 and B35.

Referring to FIGS. 3 and 5, taking the subpixel group where the green subpixel G22 is located as an example, when the image to be displayed is mapped and displayed on the OLED display screen, a first green image pixel G in the image to be displayed will be mapped to and displayed at the position of the green subpixel G22. In other words, the first green display pixel G corresponds to the green subpixel G22. After the mapping operation, the first green mapped pixel data obtained is the pixel value data of the corresponding green image pixel in the image to be displayed under the pixel arrangement structure of the OLED display screen.

Further, the directions indicated by the four arrows emitted from the first green display pixel (such as the green subpixel G22 shown in FIG. 5) are the first receiving direction, the second receiving direction, the third receiving direction and the fourth receiving direction respectively. The first receiving direction and the second receiving direction are categorized as a first setting direction, the third receiving direction and the fourth receiving direction are categorized as a second setting direction, and the first setting direction is perpendicular to the second setting direction. The first red display pixels (such as red subpixels R11 and R33 shown in FIG. 5) are respectively arranged in the first receiving direction and the second receiving direction. That is, the first red display pixels are arranged in the first setting direction. The first blue display pixels (such as blue subpixels B13 and B31 shown in FIG. 5) are respectively arranged in the third receiving direction and the fourth receiving direction. That is, the first blue display pixels are arranged in the second setting direction.

In some embodiments, at S320, if the pixel arrangement structure data indicates the diamond arrangement structure, the mapping operation is performed according to one first red image pixel in the image pixel data and two first red display pixel data in the display pixel data to obtain the first red mapped pixel data. Referring to FIGS. 3 and 5, taking the subpixel group where the green subpixel G22 is located as an example, when the image to be displayed is mapped to the OLED display screen, a first red image pixel R in the image to be displayed will be displayed on the positions of the red subpixels R11 and R33. In other words, the first red display pixel R corresponds to two red subpixels R11 and R33. After the mapping operation, the first red mapped pixel data obtained is the pixel value data of red image pixels in the image to be displayed under the pixel arrangement structure of the OLED display screen.

In some embodiments, at S330, if the pixel arrangement structure data indicates the diamond arrangement structure, the mapping operation is performed according to one first blue image pixel in the image pixel data and two first blue display pixel data in the display pixel data to obtain the first blue mapped pixel data. Referring to FIGS. 3 and 5, taking the subpixel group where the green subpixel G22 is located as an example, when the image to be displayed is mapped to the OLED display screen, the first blue image pixel B in the image to be displayed will be displayed on the positions of the blue subpixels B13 and B31. In other words, the first blue display pixel B corresponds to two blue subpixels B13 and B31. After the mapping operation, the first blue mapped pixel data obtained is the pixel value data of blue image pixels in the image to be displayed under the pixel arrangement structure of the OLED display screen.

In some embodiments, the first green mapped pixel data, the first red mapped pixel data and the first blue mapped pixel data, obtained according to the above mapping operation, are combined to obtain the original mapped pixel data at S340.

As shown in FIGS. 1 and 9, in some embodiments of the present disclosure, the OLED display device further includes a lenticular lens 200 arranged at a display end of the OLED display screen along a first preset direction. The first setting direction and the second setting direction are taken as preset arrangement directions. The first preset direction is taken as a target direction. The step S400 includes but is not limited to steps S410 to S420, which will be described in detail below.
At S410, if the first setting direction is parallel to the first preset direction, the first blue mapped pixel data is determined as target pixel data.
At S420, if the second setting direction is parallel to the first preset direction, the first red mapped pixel data is determined as target pixel data.

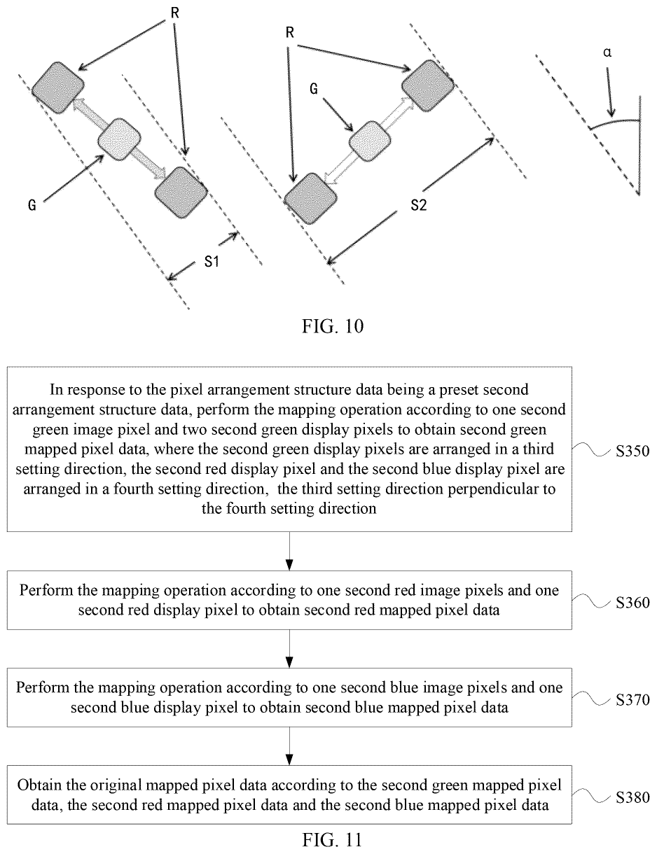

In some embodiments, at S410, the first and second setting directions are the preset arrangement directions of the display pixels, and the first preset direction is the target direction. The first preset direction is the slant direction of the lenticular lens. Referring to FIG. 10, the angle α is the slant angle of the lenticular lens. When the arrangement direction of two first red display pixels in a subpixel group (i.e., subpixel “R” shown in FIG. 10) is parallel to the first preset direction, the two first red display pixels in the arrangement direction have a first projection width S1. When the arrangement direction of two first red display pixels of a subpixel group is perpendicular to the first preset direction, the two first red display pixels in the arrangement direction have a second projection width S2. As can be seen from FIG. 10, the second projection width S2 is greater than the first projection width S1. Therefore, the two first red display pixels when their arrangement direction is perpendicular to the first preset direction have a relatively greater resolution loss, and the two first red display pixels when their arrangement direction is parallel to the first preset direction have a relatively smaller resolution loss. The greater the resolution loss, the more serious the image crosstalk is.

The first setting direction being parallel to the first preset direction, indicates that, in a subpixel group the arrangement direction of two first red display pixels is parallel to the slant direction of the lenticular lens, and the arrangement direction of two first blue display pixels is perpendicular to the slanted direction of the lenticular lens. In this way, the resolution loss of the two first blue display pixels is greater than of that of the two first red display pixels. As such, the corresponding first blue mapped pixel data is taken as the target pixel data, allowing the pixel value adjustment operation on the first blue mapped pixel data at S500, thereby reducing the color output and subsequently the resolution loss of the blue subpixel, to reduce the image crosstalk of the “re-generated” image to be displayed.

In some embodiments, at S420, when the second setting direction is parallel to the first preset direction, i.e., in a subpixel group the arrangement direction of two first blue display pixels is parallel to the slant direction of the lenticular lens, and the arrangement direction of two first red display pixels is perpendicular to the slant direction of the lenticular lens, the two first red display pixels have greater resolution loss relative to that of the two first blue display pixels. As such, the corresponding first red mapped pixel data is taken as the target pixel data, allowing the pixel value adjustment operation on the first red mapped pixel data at S500, thereby reducing the color output and subsequently the resolution loss of the red subpixel, to reduce the image crosstalk of the “re-generated” image to be displayed.

As shown in FIG. 11, in some embodiments of the present disclosure, the image pixel data includes a second red image pixel, a second green image pixel and a second blue image pixel. The display pixel data includes a second red display pixel(s), a second green display pixel(s) and a second blue display pixel(s). The step S300 may include, but is not limited to, steps S350 to S380, which will be described in detail below.
At S350, if the pixel arrangement structure data is a preset second arrangement structure data, a mapping operation is performed, according to one second green image pixel and two second green display pixels, to obtain second green mapped pixel data. The second green display pixel is arranged in a third setting direction, the second red display pixel and the second blue display pixel are arranged in a fourth setting direction, and the third setting direction is perpendicular to the fourth setting direction.
At S360, a mapping operation is performed according to one second red image pixel and one second red display pixel to obtain second red mapped pixel data.
At S370, a mapping operation is performed according to one second blue image pixel and one second blue display pixel to obtain second blue mapped pixel data.
At S380, original mapped pixel data is obtained according to the second green mapped pixel data, the second red mapped pixel data and the second blue mapped pixel data.

In some embodiments, at S350, the second arrangement structure is a 2-in-1 arrangement structure. In such a case, the mapping operation is performed according to one second green image pixel in the image pixel data and two second green display pixel data in the display pixel data to obtain the second green mapped pixel data. Referring to FIGS. 6 and 7, when the pixel arrangement structure is the 2-in-1 arrangement structure, a subpixel group in the OLED display screen 100 includes two green subpixels G, one red subpixel R and one blue subpixel B. Referring to FIG. 7, L1 to L9 are simulation points, a subpixel group may include a plurality of subpixels around one of the simulation points. For example, a subpixel group may include two green subpixels G1, one red subpixel Rx1 and one blue subpixel B12 around the simulation point L1. Another subpixel group may include two green subpixels G1 and G7, a red subpixel R45 and a blue subpixel Bx4 around the simulation point L4.

Referring to FIGS. 3 and 7, taking the subpixel group where the simulation point L1 is located as an example, when the image to be displayed is mapped to the OLED display screen, a second green image pixel G of the image to be displayed will be mapped to and then displayed at the position of two green subpixels G1 adjacent to L1. In other words, the second green display pixel G corresponds to two green subpixels G1. After the mapping operation, the second green mapped pixel data obtained is the pixel value data of the green image pixels in the image to be displayed under this pixel arrangement structure of the OLED display screen. Here, the second green display pixel (such as the green subpixel G1 shown in FIG. 7) is arranged in a third setting direction, while the second red display pixel (such as the red subpixel Rx1 shown in FIG. 7) and the second blue display pixel (such as the blue subpixel B12 shown in FIG. 7) are arranged in a fourth setting direction respectively. The third setting direction is perpendicular to the fourth setting direction.

In some embodiments, referring to FIG. 7, at S360, if the pixel arrangement structure data indicates the 2-in-1 arrangement structure, the mapping operation is performed according to one second red image pixel in the image pixel data and one second red display pixel data in the display pixel data to obtain the second red mapped pixel data. Referring to FIGS. 3 and 7, taking the subpixel group where the simulation point L1 is located as an example, when the image to be displayed is mapped to the OLED display screen, a second red image pixel R of the image to be displayed will be displayed at the position of the red subpixel Rx1. In other words, the second red display pixel R corresponds to the red subpixel Rx1. After the mapping operation, the second red mapped pixel data obtained is the pixel value data of the red image pixels in the image to be displayed under this pixel arrangement structure of the OLED display screen.

In some embodiments, referring to FIG. 7, if the pixel arrangement structure data indicates the 2-in-1 arrangement structure data, the mapping operation is performed according to one second blue image pixel in the image pixel data and a second blue display pixel data in the display pixel data to obtain the second blue mapped pixel data at S370. Referring to FIGS. 3 and 7, taking the subpixel group where the simulation point L1 is located as an example, when the image to be displayed is mapped to the OLED display screen, a second blue image pixel B in the image to be displayed will be displayed at the position of the blue subpixel B12. That is, the second blue display pixel B corresponds to the blue subpixel B12. After the mapping operation, the second blue mapped pixel data obtained is the pixel value data of the blue image pixels in the image to be displayed under this pixel arrangement structure of the OLED display screen 100.

In some embodiments, at S380, the second green mapped pixel data, the second red mapped pixel data and the second blue mapped pixel data, obtained by the above mapping operation, are combined to obtain the original mapped pixel data.

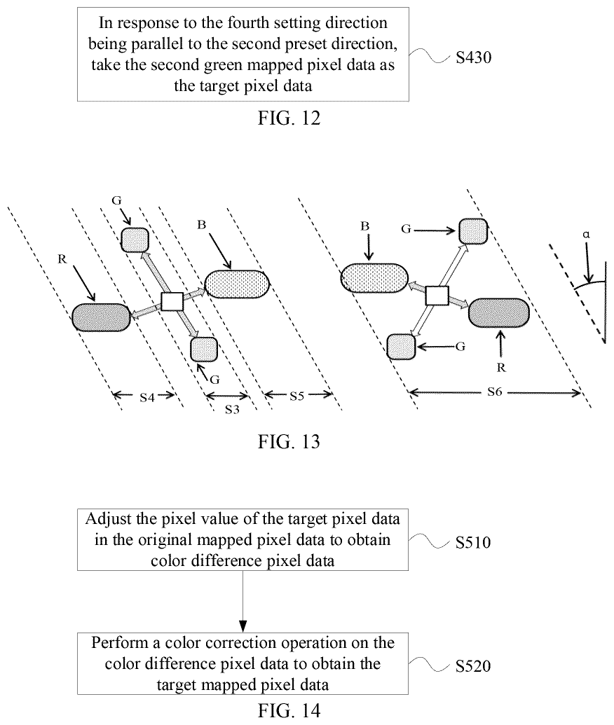

As shown in FIG. 12, in some embodiments of the present disclosure, the OLED display device includes a lenticular lens arranged in a second preset direction. The third setting direction and the fourth setting direction are taken as the preset arrangement directions. The second preset direction is taken as the target direction. The step S400 may include, but is not limited to, a step S430, which will be described in detail below.
At S430, if the fourth setting direction is parallel to the second preset direction, the second green mapped pixel data is determined as target pixel data.

In some embodiments, at S430, the third and fourth setting directions are the preset arrangement directions of the display pixels. The second preset direction is taken as the target direction, that is, the second preset direction is the slant direction of the lenticular lens. Referring to FIG. 13, the lenticular lens has a slant angle α. When the arrangement directions of two second green display pixels (i.e., subpixels “G” in FIG. 13) of a subpixel group are parallel to the second preset direction, the two second green display pixels have a third projection width S3 in their arrangement directions, a second red display pixel (i.e., subpixel “R” in FIG. 13) has a fourth projection width S4, and a second blue display pixel (i.e., subpixel “B” in FIG. 13) has a fifth projection width S5. When the arrangement directions of two second green display pixels of a subpixel group are perpendicular to the second preset direction, the two second green display pixels have a sixth projection width S6 in the arrangement direction. Both the fourth projection width S4 of the second red display pixel and the fifth projection width S5 of the second blue display pixel remain the same. As can be seen from FIG. 13 that, the sixth projection width S6 is greater than the third projection width S3, and the fourth projection width S4 of the second red display pixel and the fifth projection width S5 of the second blue display pixel will not change with the change of the arrangement directions. Therefore, the two second green display pixels have greater resolution loss when their arrangement directions are perpendicular to the second preset direction, and have smaller resolution loss when their arrangement directions are parallel to the second preset direction. Meanwhile, the greater the resolution loss, the more serious the image crosstalk is.

The fourth setting direction being parallel to the second preset direction, indicates that the arrangement directions of two second green display pixels in a subpixel group are perpendicular to the slant direction of the lenticular lens, and the resolution loss of the two second green display pixels is larger. In such a case, the corresponding second green mapped pixel data is determined as the target pixel data, allowing the pixel value adjustment operation on the second green mapped pixel data at S500 to reduce the color output of the green subpixels, thereby reducing the resolution loss of the green subpixel, to prevent the image crosstalk of the “re-generated” image to be displayed.

As shown in FIG. 14, in some embodiments of the present disclosure, the step S500 may include, but is not limited to, steps S510 to S520, which are described in detail below.
At S510, a pixel value adjustment operation is performed on the target pixel data in the original mapped pixel data to obtain chromatic aberration pixel data.
At S520, a color correction operation is performed on the chromatic aberration pixel data to obtain target mapped pixel data.

In some embodiments, at S510, after the pixel value of the target pixel data in the original mapped pixel data is adjusted, the color output of the subpixels corresponding to the target pixel data will be suppressed, while the color output of the other subpixels will remain unchanged, which may lead to color imbalance in the obtained chromatic aberration pixel data.

In some embodiments, at S520, the color correction operation is performed on the obtained chromatic aberration pixel data. For example, the color values of three subpixels of red, green and blue may be adjusted by a gamma correction method, so as to obtain the target mapped pixel data with balanced color values for the subpixels of the three types.

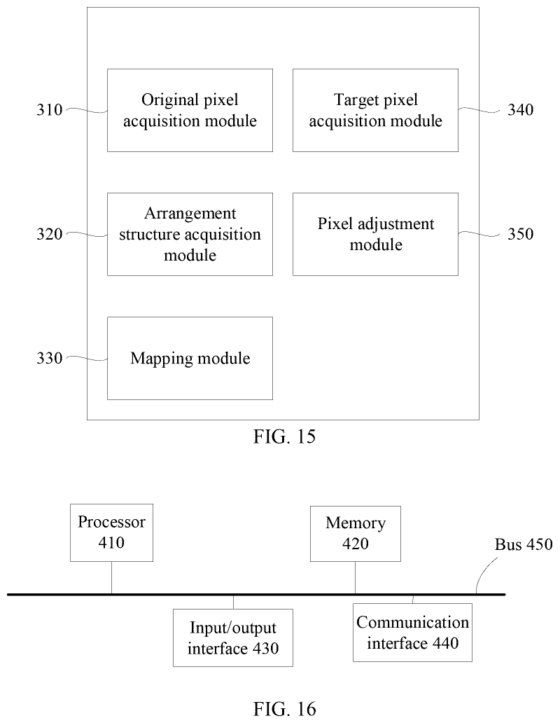

As shown in FIG. 15, a system for generating an image is provided according to some embodiments of the present disclosure. The system may include:
an original pixel acquisition module 310, configured to acquire original pixel data of an image to be displayed, where the original pixel data includes image pixel data;
an arrangement structure acquisition module 320, configured to acquire pixel arrangement structure data of an OLED display screen, where the pixel arrangement structure data includes display pixel data arranged in a preset arrangement direction;
a mapping module 330, configured to perform a mapping operation according to the image pixel data and the display pixel data to obtain original mapped pixel data;
a target pixel acquisition module 340, configured to determine the target pixel data in the original mapped pixel data according to a preset target direction and the preset arrangement direction;
a pixel adjustment module 350, configured to perform a pixel value adjustment on the target pixel data in the original mapped pixel data to obtain target mapped pixel data, where the OLED display screen is configured to perform display operation according to the target mapped pixel data to display the re image to be displayed on the OLED display screen.

It can be seen that, the steps of the method of any one of embodiments of the present disclosure are all applicable to the systems according to the embodiments of the present disclosure. The functions realized by the systems described by the above embodiments, as well as the beneficial effects, are the same as those according to the method described by the above embodiments.

An OLED display device is provided according to the embodiments of the present disclosure, which includes a controller, an OLED display screen and a lenticular lens, where, the controller and its functional program are configured to execute the method described in any of the above embodiments. The OLED display screen is utilized for electrically connecting with the controller. The lenticular lens is arranged at a display end of the OLED display screen along a target direction.

It can be seen that, the steps of the method of any one of embodiments of the present disclosure are all applicable to the display device according to the embodiments of the present disclosure. The functions realized by the display device described by the above embodiments, as well as the beneficial effects, are the same as those according to the method described by the above embodiments.

The electronic device according to the embodiments of the present disclosure will be described in detail with reference to FIG. 16.

FIG. 16 depicts a schematic diagram showing a hardware structure of the electronic equipment according to an embodiment of the present disclosure. The electronic equipment may include:
a processor 410, configured to execute related programs to implement the technical scheme provided by the embodiments of the present disclosure, which can be realized by a general Central Processing Unit (CPU), a microprocessor, an application specific integrated circuit (ASIC), or one or more integrated circuits.
a memory 420, which may be implemented in the form of Read Only Memory (ROM), static storage device, dynamic storage device or Random Access Memory (RAM); the memory 420 can store an operating system, application programs and the relevant program codes, which can be called to carry out the methods described in the above embodiments by the processor 410 when the technical schemes provided in the above embodiments is implemented through software or firmware.
an input/output interface 430, configured to realize information input and output.
a communication interface 440, configured to enable the communicative interactions between the device and other devices, which can be realized in wired means (such as USB, network cable, etc.) or wireless means (such as mobile network, WIFI, Bluetooth, etc.).
a bus 450, configured to transmit and receive information among various components of the device, e.g., the processor 410, the memory 420, the input/output interface 430 and the communication interface 440.

The communication connection among the processor 410, the memory 420, the input/output interface 430 and the communication interface 440 can be realized through the bus 450 herein.

A computer-readable storage medium is provided according to the embodiments of the present disclosure. The storage medium stores computer-executable instructions which, when executed by a processor, causes the processor to carry out the method according to any one of embodiments of the present disclosure.

It can be seen that the steps of the method of any one of embodiments of the present disclosure are all applicable to the storage medium according to the embodiments of the present disclosure. The functions as well as the beneficial effects realized by the embodiments of the system are the same as those according to the embodiments of the above method.

The device embodiments described above are merely illustrative. The units described as separate components may or may not be physically separated. That is, the units may be located in one place or distributed to a plurality of network units. Part or all of the modules can be selected as required to achieve the purpose of the embodiments.

It should be understood by those skilled in the art that, all or some of the steps in the above methods, systems and functional modules/units in the device can be implemented as software, firmware, hardware and their appropriate combinations.

Those skilled in the art can understand that all or some of the steps, systems and functional modules/units in the methods disclosed above can be implemented as software, firmware, hardware and their appropriate combinations.

The terms “first”, “second”, “third” and “fourth” in the description and the accompanying drawings, if any, are used to distinguish similar objects, and are not necessarily used to describe a specific order or sequence. It should be understood that the data so used are interchangeable under appropriate circumstances, so that the embodiments of the present disclosure described herein can be implemented in other orders than those illustrated or described herein. Furthermore, the terms “include” and “have” and any variations thereof are intended to cover non-exclusive inclusion, for example, a process, method, system, product or equipment that includes a series of steps or units is not necessarily limited to those explicitly listed, but may include other steps or units not explicitly listed or inherent to such processes, methods, products or equipment.

It should be understood that in the present disclosure, “at least one (item)” means one or more, and “a plurality of” means two or more. “and/or” is used to describe the relationship of the involved objects, indicating that there can be three kinds of relationships. For example, “A and/or B” can indicate that there are only A, only B, and both A and B, where A and B can be singular or plural. The character “/” generally indicates that the involved object is an OR relationship. “At least one of the following (items)” or its similar expression refers to any combination of these items, including any combination of single (items) or multiple (items). For example, at least one of A, B or C can be expressed as: A, B, C, A and B, A and C, B and C, or A and B and C, where A, B and C can be single or multiple.

It should be understood that, in several embodiments provided by the present disclosure, the disclosed devices and methods can be realized in other ways. For example, the device embodiments described above are merely illustrative. For example, the division of units is only a logical function division., other division means may be selected in actual implementation. For example, multiple units or components can be combined or integrated into another system, or some features can be ignored or not implemented. Another thing is that the mutual coupling or direct coupling or communication connection shown or discussed can be indirect coupling or communication connection through some interfaces, devices or units, which can be electrical, mechanical or other forms.

The units described as separate pieces may or may not be physically separated, and the components represented as units may or may not be physical units, that is, they may be located in one place or distributed to multiple network units. Some or all of the units can be selected as required to achieve the purpose of the embodiments of the present disclosure.

Furthermore, each functional unit in each embodiment of the present disclosure may be integrated into one processing unit, or each unit may exist physically alone, or two or more units may be integrated into one unit. The above integrated units can be realized in the form of hardware or software functional units.

An integrated unit can be stored in a computer-readable storage medium if they are implemented in the form of software functional units and sold or used as an independent product. In view of this, the technical solution of the present disclosure can be embodied in the form of a software product, which is stored in a storage medium and includes a plurality of instructions to cause an electronic device (which can be a personal computer, a server, a network device, etc.) to perform all or part of the steps of the methods of various embodiments of the present disclosure. The aforementioned storage medium may include: U disk, mobile hard disk, Read-Only Memory (ROM), Random Access Memory (RAM), magnetic disk or optical disk and other mediums that can store programs.

The preferred embodiments of the embodiments of the present disclosure have been described above with reference to the accompany drawings, and the scope of the embodiments of the present disclosure is not limited thereto. Any modification, equivalent substitution and improvement made by those skilled in the art without departing from the scope and essence of the embodiments disclosed should be within the scope of the embodiments disclosed.

What is claimed is:

1. A method for generating an image, applied to an Organic Light Emitting Diode, OLED, display device comprising an OLED display screen, the method comprising:
acquiring original pixel data of an image to be displayed, wherein the original pixel data comprises image pixel data;
acquiring pixel arrangement structure data of the OLED display screen, wherein the pixel arrangement structure data comprises display pixel data arranged in a preset arrangement direction;
performing a mapping operation according to the image pixel data and the display pixel data to obtain original mapped pixel data;
determining target pixel data in the original mapped pixel data according to a preset target direction and the preset arrangement direction; and
performing a pixel value adjustment operation on the target pixel data in the original mapped pixel data to obtain target mapped pixel data, wherein the OLED display screen is configured to perform display operation according to the target mapped pixel data to display the image to be displayed on the OLED display screen.

2. The method according to claim 1, wherein, the image pixel data comprises a first red image pixel, a first green image pixel and a first blue image pixel, and the display pixel data comprises a first red display pixel(s), a first green display pixel(s) and a first blue display pixel(s); and
performing a mapping operation according to the image pixel data and the display pixel data to obtain original mapped pixel data comprises:
performing, in response to the pixel arrangement structure data being a preset first arrangement structure data, the mapping operation according to one first green image pixel and one first green display pixel to obtain first green mapped pixel data; wherein, the first green display pixel has a first receiving direction, a second receiving direction, a third receiving direction and a fourth receiving direction, the first receiving direction and the second receiving direction are categorized as a first setting direction, the third receiving direction and the fourth receiving direction are categorized as a second setting direction, and the first setting direction is perpendicular to the second setting direction; the first red display pixels are arranged in the first receiving direction and the second receiving direction, and the first blue display pixels are arranged in the third receiving direction and the fourth receiving direction;
performing the mapping operation according to one first red image pixel and two first red display pixels to obtain first red mapped pixel data;
performing the mapping operation according to one first blue image pixel and two first blue display pixels to obtain first blue mapped pixel data; and
obtaining original mapped pixel data according to the first green mapped pixel data, the first red mapped pixel data and the first blue mapped pixel data.

3. The method according to claim 2, wherein, the OLED display device further comprises a lenticular lens arranged at a display end of the OLED display screen in a first preset direction, and the first setting direction and the second setting direction are taken as the preset arrangement direction, and the first preset direction is taken as the present target direction; and
determining target pixel data in the original mapped pixel data according to a preset target direction and the preset arrangement direction comprises:
taking, in response to the first setting direction being parallel to the first preset direction, the first blue mapped pixel data as the target pixel data; and
taking, in response to the second setting direction being parallel to the first preset direction, the first red mapped pixel data as the target pixel data.

4. The method according to claim 1, wherein, the image pixel data comprises a second red image pixel, a second green image pixel and a second blue image pixel, and the display pixel data comprises a second red display pixel(s), a second green display pixel(s) and a second blue display pixel(s); and
performing a mapping operation according to the image pixel data and the display pixel data to obtain original mapped pixel data comprises:
performing, in response to the pixel arrangement structure data being a preset second arrangement structure data, the mapping operation according to one second green image pixel and two second green display pixels to obtain second green mapped pixel data, wherein the second green display pixels are arranged in a third setting direction, the second red display pixel and the second blue display pixel are arranged in a fourth setting direction, and the third setting direction is perpendicular to the fourth setting direction;
performing the mapping operation according to one second red image pixel and one second red display pixel to obtain second red mapped pixel data;
performing the mapping operation according to one second blue image pixel and one second blue display pixel to obtain second blue mapped pixel data; and
obtaining the original mapped pixel data according to the second green mapped pixel data, the second red mapped pixel data and the second blue mapped pixel data.

5. The according to claim 4, wherein, the OLED display device further comprises a lenticular lens arranged in a second preset direction, and the third setting direction and the fourth setting direction are taken as the preset arrangement direction, and the second preset direction are taken as the preset target direction; and
determining target pixel data in the original mapped pixel data according to a preset target direction and the preset arrangement direction comprises:
taking, in response to the fourth setting direction being parallel to the second preset direction, the second green mapped pixel data as the target pixel data.

6. The method according to claim 1, wherein, performing a pixel value adjustment operation on the target pixel data in the original mapped pixel data to obtain target mapped pixel data comprises:
performing the pixel value adjusting operation on the target pixel data in the original mapped pixel data to obtain color difference pixel data; and
performing a color correction operation on the color difference pixel data to obtain the target mapped pixel data.

7. A system for generating an image, comprising:
an original pixel acquisition module, configured to acquire original pixel data of an image to be displayed, wherein the original pixel data comprises image pixel data;
an arrangement structure acquisition module, configured to acquire pixel arrangement structure data of an OLED display screen, wherein the pixel arrangement structure data comprises display pixel data arranged in a preset arrangement direction;
a mapping module, configured to perform a mapping operation according to the image pixel data and the display pixel data to obtain original mapped pixel data;
a target pixel acquisition module, configured to determine target pixel data in the original mapped pixel data according to a preset target direction and the preset arrangement direction; and
a pixel adjustment module, configured to perform a pixel value adjustment operation on the target pixel data in the original mapped pixel data to obtain target mapped pixel data, wherein the OLED display screen is configured to perform display operation according to the target mapped pixel data to display the image to be displayed on the OLED screen.

8. An OLED display device, comprising:
a controller, configured to carry out the method according to claim 1;
an OLED display screen, configured to electrically connect to the controller; and
a lenticular lens, arranged at a display end of the OLED display screen in a target direction.

9. An electronic equipment, comprising:
at least one processor; and
at least one memory storing at least one computer program which, when executed by the at least one processor, causes the at least one processor to carry out the method according to claim 1.

10. A computer-readable non-transitory storage medium, storing computer-executable instructions which, when executed by a processor, causes the processor to carry out the method according to claim 1.
